(19) United States
(12) Patent Application Publication
(10) Pub. No.: US 2025/0333649 A1
(43) Pub. Date: Oct. 30, 2025

(54) HIGH-BRIGHTNESS HIGH-LUMINOUS-EFFICIENCY COMPLEX-PHASE FLUORESCENT CERAMIC FOR LASER ILLUMINATION AND PREPARATION METHOD THEREFOR

(71) Applicants: Jiangsu Normal University, Xuzhou (CN); Jiangsu Xiyi Advanced Materials Research Institute Of Industrial Technology Co., LTD, Xuzhou (CN); Xuzhou All To Photoelectric Technology Co., LTD, Xuzhou (CN); Suzhou University of Science and Technology, Suzhou (CN)

(72) Inventors: Le ZHANG, Xuzhou (CN); Xuanchu LIU, Xuzhou (CN); Jinhua WANG, Xuzhou (CN); Chang MIN, Xuzhou (CN); Yanbin LI, Xuzhou (CN); Jian KANG, Xuzhou (CN); Chunming ZHOU, Xuzhou (CN); Tianyuan ZHOU, Xuzhou (CN); Hao CHEN, Suzhou (CN); Guocan HUANG, Xuzhou (CN)

(21) Appl. No.: 19/262,229

(22) Filed: Jul. 8, 2025

Related U.S. Application Data
(63) Continuation of application No. PCT/CN2023/117952, filed on Sep. 11, 2023.

(30) Foreign Application Priority Data
Apr. 20, 2023 (CN) 2023104342990

(51) Int. Cl. C09K 11/77; C04B 35/44; C04B 35/626; C04B 35/645; C09K 11/02

(52) U.S. Cl. CPC C09K 11/7774; C04B 35/44; C04B 35/6261; C04B 35/6264; C04B 35/62655; C04B 35/62675; C04B 35/645; C09K 11/02; C04B 2235/3222; C04B 2235/5436; C04B 2235/606; C04B 2235/6567; C04B 2235/666; C04B 2235/763; C04B 2235/764

(57) ABSTRACT

A high-brightness high-luminous-efficiency complex-phase fluorescent ceramic for laser illumination and a preparation method therefor are provided. The complex-phase fluorescent ceramic is prepared from Ce:LuAG powder and SrAl₂O₄ power as ceramic raw material powder by using a spark plasma sintering method. Ce:LuAG serves as a ceramic body, and SrAl₂O₄ is introduced as a second phase. The introduction of SrAl₂O₄ as the second phase can significantly inhibit grain growth of LuAG, so that the Ce:LuAG particles are small and uniformly distributed, and the prepared complex-phase fluorescent ceramic has high brightness and high luminous-efficiency. The fluorescent ceramic has better luminescence characteristics, and solves problems in the related art of poor thermal stability and low light conversion efficiency, and the preparation method is simple, the time is short, the sintering temperature is low, can be applied to high-power LEDs/LDs devices, and greatly improves the application value of the devices.

### CROSS-REFERENCE TO RELATED APPLICATIONS

This application is a continuation of International Patent Application No. PCT/CN 2023/117952, filed on Sep. 11, 2023, which claims the priority of Chinese Patent Application No. 202310434299.0, filed on Apr. 20, 2023, both of which are herein incorporated by reference in their entirety.

### TECHNICAL FIELD

The disclosure relates to the technical field of fluorescent ceramics, and more particularly to a high-brightness high-luminous-efficiency complex-phase fluorescent ceramic for laser illumination and a preparation method therefor.

### BACKGROUND

LuAG is an abbreviation of lutetium aluminum garnet with a chemical formula is Lu₃Al₅O₁₂. LuAG is a solid solution formed by lutetium oxide (Lu₂O₃) and aluminum oxide (Al₂O₃), which belongs to a cubic crystal system, has a garnet structure, does not have a birefringence effect, and can be made into transparent ceramics with excellent optical properties. At the same time, LuAG has high density (6.73 grams per cubic centimeter, which is abbreviated as g/cm³, equivalent to 94% of a density of bismuth germanate (Bi₄Ge₃O₂), which is abbreviated as BGO), high melting point (2010 Celsius degrees, which is abbreviated as ° C.), high effective atomic number (Z_{eff}=60), and good mechanical properties, thus it can maintain stable optical, physical and chemical properties under long-term radiation conditions.

Cerium-doped lutetium aluminum garnet (Ce:LuAG) transparent ceramic phosphor has been widely studied as a promising candidate material for color converters for white light-emitting diode (LED) lighting due to its excellent thermal and chemical stability. The Shanghai Institute of Silicates used a solid-phase reaction method to prepare transparent LuAG:Ce ceramics under vacuum sintering conditions at 1760° C. for 10 hours (h). However, transmittance of the transparent LuAG:Ce ceramics is low, which is 56% in a visible light range. In addition, the high sintering temperature of 1760° C. also limits a large-scale application of the transparent LuAG:Ce ceramics. A Chinese patent NO. CN110550945B discloses a method for preparing LuAG:Ce transparent ceramics and LuAG:Ce transparent ceramics, which can solve the problems of low transmittance of LuAG:Ce ceramics in the visible light range in the related art and the limitation of large-scale application due to high sintering temperature during preparation.

However, although Ce:LuAG transparent ceramic phosphor has a high light transmittance, its cubic crystal structure results in less absorption of cerium(III) ions (Ce³⁺) by blue light emitted by indium gallium nitride (InGaN) chips, lower yellow light conversion efficiency, and the Ce:LuAG transparent ceramic phosphor has problems of poor thermal stability, and low light conversion efficiency.

### SUMMARY

Aiming at the technical disadvantages in the related art, an objective of the disclosure is to provide a high-brightness high-luminous-efficiency complex-phase fluorescent ceramic for laser illumination and a preparation method therefor. The fluorescent ceramic has better luminous characteristics, solves problems of poor thermal stability and low light conversion efficiency in the related art. The preparation method of the complex phase ceramic is simple, short in time and low in sintering temperature, and can be applied to high-power light-emitting diodes/lighting diodes (LEDs/LDs) devices, which greatly improves application value of the device.

In order to solve the above problems, a second phase is introduced into a ceramic body to control its light transmittance and enhance an optical path. Strontium aluminum oxide (SrAl₂O₄) is used as the second phase to prepare a Ce:LuAG complex-phase fluorescent ceramic. An introduction of SrAl₂O₄ can significantly improve uniformity of emitted light of the composite fluorescent ceramic, making it more suitable for white light laser diode illumination.

SrAl₂O₄ is a widely used traditional ceramic, which has attracted wide attention due to its unique properties. Compared with Al₂O₃, SrAl₂O₄ belongs to a hexagonal system with a lower refractive index, which helps to reduce total reflection loss and improve light extraction efficiency. In addition, a vacuum sintering temperature of SrAl₂O₄ is the same as that of Ce:LuAG, which facilitates a one-step vacuum sintering preparation of SrAl₂O₄—Ce:LuAG.

Specific technical solutions adopted by the disclosure are as follows.

A first objective of the disclosure is to provide a high-brightness high-luminous-efficiency complex-phase fluorescent ceramic for laser illumination, the complex-phase fluorescent ceramic is prepared from Ce:LuAG powder and SrAl₂O₄ powder as ceramic raw material powder by using a spark plasma sintering method. Ce:LuAG is configured to be the ceramic body (i.e., a first phase), and SrAl₂O₄ is introduced as the second phase to prepare the complex-phase fluorescent ceramic, which has high brightness and high luminous-efficiency.

A second objective of the disclosure is to provide a preparation method of the high-brightness high-luminous-efficiency complex-phase fluorescent ceramic for laser illumination, including:
S1, weighing, according to a mass ratio of the Ce:LuAG powder and the SrAl₂O₄ powder, the Ce:LuAG powder and the SrAl₂O₄ powder individually as the ceramic raw material powder, where a mass of the SrAl₂O₄ powder accounts for 5% to 25% of a total mass of the ceramic raw material powder;
S2, mixing the Ce:LuAG powder and the SrAl₂O₄ powder to obtain mixed powder, adding anhydrous ethanol into the mixed powder, and ball milling mixed powder added with the anhydrous ethanol fully to obtain a slurry;
S3, taking out and drying the slurry obtained by ball milling to obtain dried powder; and
S4, performing spark plasma sintering on the dried powder under vacuum to obtain sintered powder, and cooling the sintered powder to room temperature to obtain the complex-phase fluorescent ceramic.

In an embodiment, in step S1, a particle size of the Ce:LuAG powder is in a range of 1 micron (μm) to 1.3 μm, a particle size of the SrAl₂O₄ powder is in a range of 1.5 μm to 2 μm, and a pureness of each of the Ce:LuAG powder and the SrAl₂O₄ powder is above 99.99%.

In an embodiment, in step S2, a speed of the ball milling is in a range of 180 revolutions per minute (rpm) to 250 rpm, and a time of the ball milling is in a range of 15 h to 30 h.

In an embodiment, in step S3, a temperature of the drying is in a range of 70° C. to 90° C., and a time of the drying is in a range of 8 h to 12 h.

In an embodiment, in step S4, a sintering pressure of the spark plasma sintering is in a range of 50 megapascals (MPa) to 100 MPa, a pulse current of the spark plasma sintering is in a range of 200 amperes (A) to 400 A, a heat preservation sintering time of the spark plasma sintering is in a range of 20 minutes (min) to 50 min, and a sintering temperature of the spark plasma sintering is in a range of 1650° C. to 1800° C.

Beneficial effects of the disclosure are as follows.

1. The vacuum sintering temperature of SrAl₂O₄ used in the disclosure is the same as that of Ce:LuAG, which is convenient for one-step vacuum sintering, has lower cost and is more environmentally friendly.

2. The disclosure adopts SrAl₂O₄—Ce:LuAG complex-phase, and through the introduction of SrAl₂O₄ as the second phase, grain growth of LuAG is significantly inhibited, so that the Ce:LuAG particles are small and uniformly distributed, and a light extraction rate is effectively improved.

3. The SrAl₂O₄—Ce:LuAG complex-phase prepared by the disclosure has high thermal stability and low thermal quenching rate (920%@150° C.). Compared with pure Ce:LuAG fluorescent ceramics, it has better luminescence characteristics. Under excitation of a 20 watts (W) blue light LD chip, there is no luminescence saturation, especially when an input power is 4 W to 5 W, a maximum luminous flux of 20 weight percent (wt %) SrAl₂O₄—Ce:LuAG can reach 800 lumens (lm) to 1000 lm, which greatly improves the application value of the device.

4. The disclosure prepares the SrAl₂O₄—Ce:LuAG composite-phase ceramics with high brightness and high luminous-efficiency through the spark plasma sintering (SPS) method. The preparation method is simple, the time is short, the sintering temperature is low, and it can be applied to high-power LEDs/LDs devices.

### BRIEF DESCRIPTION OF DRAWINGS

In order to more clearly illustrate technical solutions in embodiments of the disclosure or in the related art, drawings required for use in descriptions of the embodiments or the related art will be briefly introduced below. Apparently, the drawings described below are merely some of the embodiments of the disclosure. For those skilled in the art, other drawings can be obtained based on these drawings without creative work.

FIG. 1 illustrates an X-ray diffraction (XRD) comparison diagram of a sample SrAl₂O₄—Ce:LuAG prepared in an embodiment 2 in the disclosure, LuAG and SrAl₂O₄.

FIG. 2 illustrates an electroluminescence (EL) spectrum diagram of the sample SrAl₂O₄—Ce:LuAG prepared in the embodiment 2 in the disclosure under excitation by a LD chip at 450 nanometers (nm).

FIG. 3 illustrates a schematic comparison diagram of relationship between luminous flux and input power of a sample of SrAl₂O₄ accounting for 25% of a total mass of ceramic raw materials prepared in an embodiment 1 in the disclosure, a sample of SrAl₂O₄ accounting for 20% of the total mass of the ceramic raw materials prepared in the embodiment 2 in the disclosure and a pure Ce:LuAG sample.

### DETAILED DESCRIPTION OF EMBODIMENTS

Technical solutions in embodiments of the disclosure will be clearly and completely described in conjunction with drawings in the embodiments of the disclosure below. Apparently, the described embodiments are merely some of the embodiments of the disclosure, not all of the embodiments. Based on the embodiments of the disclosure, all other embodiments obtained by those skilled in the art without creative work are within a scope of protection of the disclosure.

Ce:LuAG powder and SrAl₂O₄ powder used in the following embodiments are both commercially available products.

### Embodiment 1

According to a mass of SrAl₂O₄ accounting for 25% of a total mass of ceramic raw materials in a chemical formula SrAl₂O₄—Ce:LuAG, and according to a stoichiometric ratio of the corresponding raw materials, 45 grams (g) of Ce:LuAG powder with a pureness of 99.99% and a particle size of 1.2 μm, and 15 g of SrAl₂O₄ powder with a pureness of 99.99% and a particle size of 1.7 μm are individually weighed. The Ce:LuAG powder and the SrAl₂O₄ powder are mixed to obtain mixed powder. Anhydrous ethanol is added into the mixed powder, and the mixed powder added with the anhydrous ethanol is ball milled fully to obtain a slurry. The slurry obtained by ball milling is dried in an oven at 90° C. for 12 h to obtain dried powder. The dried powder is wrapped with a graphite paper and then spark plasma sintered under vacuum with a sintering pressure of 80 MPa, a pulse current of 300 A, a heat preservation sintering time of 40 min and a sintering temperature of 1700° C. to obtain sintered powder. The sintered powder is cooled to the room temperature to obtain the complex-phase fluorescent ceramic.

Under the excitation of a blue light LD chip with a wavelength of around 450 nm, the complex-phase fluorescent ceramic emits high-brightness broadband yellow light at around 540 nm. Compared with pure Ce:LuAG, it shows excellent luminescence performance under the excitation of the blue light LD. When an input power is 4.5 W, the 25 wt % SrAl₂O₄—Ce:LuAG reaches a maximum luminous flux of 800 lm.

### Embodiment 2

According to a mass of SrAl₂O₄ accounting for 20% of the total mass of the ceramic raw materials in the chemical formula SrAl₂O₄—Ce:LuAG, and according to a stoichiometric ratio of the corresponding raw materials, 48 grams (g) of Ce:LuAG powder with a pureness of 99.99% and a particle size of 1.2 μm, and 12 g of SrAl₂O₄ powder with a pureness of 99.99% and a particle size of 1.7 μm are individually weighed. The Ce:LuAG powder and the SrAl₂O₄ powder are mixed to obtain mixed powder. Anhydrous ethanol is added into the mixed powder, and the mixed powder added with the anhydrous ethanol is ball milled fully to obtain a slurry. The slurry obtained by ball milling is dried in an oven at 90° C. for 12 h to obtain dried powder. The dried powder is wrapped with a graphite paper and then spark plasma sintered under vacuum with a sintering pressure of 80 MPa, a pulse current of 300 A, a heat preservation sintering time of 40 min and a sintering temperature of 1700° C. to obtain sintered powder. The sintered powder is cooled to the room temperature to obtain the complex-phase fluorescent ceramic.

Under the excitation of the blue light LD chip with a wavelength of around 450 nm, the complex-phase fluorescent ceramic emits high-brightness broadband yellow light at around 540 nm. When the input power is 5 W, the 20 wt % SrAl₂O₄—Ce:LuAG does not show luminous saturation, and a luminous flux can reach 1000 lm.

### Embodiment 3

According to a mass of SrAl₂O₄ accounting for 10% of the total mass of the ceramic raw materials in the chemical formula SrAl₂O₄—Ce:LuAG, and according to a stoichiometric ratio of the corresponding raw materials, 54 grams (g) of Ce:LuAG powder with a pureness of 99.99% and a particle size of 1.2 μm, and 6 g of SrAl₂O₄ powder with a pureness of 99.99% and a particle size of 1.7 μm are individually weighed. The Ce:LuAG powder and the SrAl₂O₄ powder are mixed to obtain mixed powder. Anhydrous ethanol is added into the mixed powder, and the mixed powder added with the anhydrous ethanol is ball milled fully to obtain a slurry. The slurry obtained by ball milling is dried in an oven at 90° C. for 12 h to obtain dried powder. The dried powder is wrapped with a graphite paper and then spark plasma sintered under vacuum with a sintering pressure of 80 MPa, a pulse current of 300 A, a heat preservation sintering time of 40 min and a sintering temperature of 1700° C. to obtain sintered powder. The sintered powder is cooled to the room temperature to obtain the complex-phase fluorescent ceramic.

Under the excitation of the blue light LD chip with a wavelength of around 450 nm, the complex-phase fluorescent ceramic emits high-brightness broadband yellow light at around 540 nm. When the input power is 3.3 W, the 10 wt % SrAl₂O₄—Ce:LuAG reaches a maximum luminous flux 600 lm.

### Embodiment 4

According to a mass of SrAl₂O₄ accounting for 5% of the total mass of the ceramic raw materials in the chemical formula SrAl₂O₄—Ce:LuAG, and according to a stoichiometric ratio of the corresponding raw materials, 57 grams (g) of Ce:LuAG powder with a pureness of 99.99% and a particle size of 1.2 μm, and 3 g of SrAl₂O₄ powder with a pureness of 99.99% and a particle size of 1.7 μm are individually weighed. The Ce:LuAG powder and the SrAl₂O₄ powder are mixed to obtain mixed powder. Anhydrous ethanol is added into the mixed powder, and the mixed powder added with the anhydrous ethanol is ball milled fully to obtain a slurry. The slurry obtained by ball milling is dried in an oven at 90° C. for 12 h to obtain dried powder. The dried powder is wrapped with a graphite paper and then spark plasma sintered under vacuum with a sintering pressure of 80 MPa, a pulse current of 300 A, a heat preservation sintering time of 40 min and a sintering temperature of 1700° C. to obtain sintered powder. The sintered powder is cooled to the room temperature to obtain the complex-phase fluorescent ceramic.

Under the excitation of the blue light LD chip with a wavelength of around 450 nm, the complex-phase fluorescent ceramic emits high-brightness broadband yellow light at around 540 nm. When the input power is 2.4 W, the 5 wt % SrAl₂O₄—Ce:LuAG reaches a maximum luminous flux 400 lm.

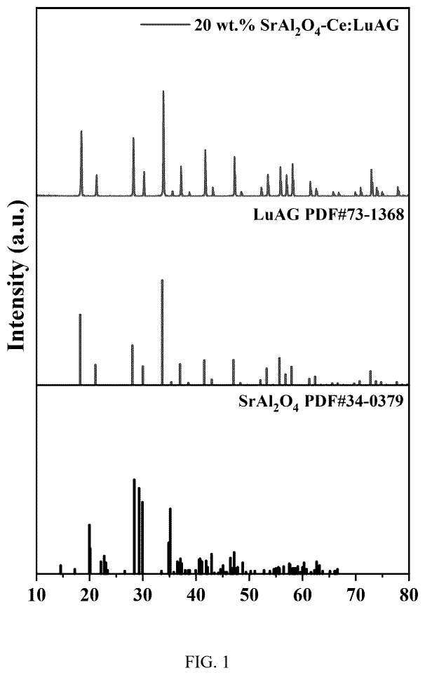

FIG. 1 illustrates an XRD comparison diagram of a sample SrAl₂O₄—Ce:LuAG prepared in the embodiment 2 in the disclosure, LuAG and SrAl₂O₄. It can be seen from FIG. 1, diffraction peaks of the 20 wt % SrAl₂O₄—Ce:LuAG sample correspond well to standard portable document format (PDF) cards of the SrAl₂O₄ and LuAG, and no other impurities are produced, indicating that a crystallization performance of the sample is good.

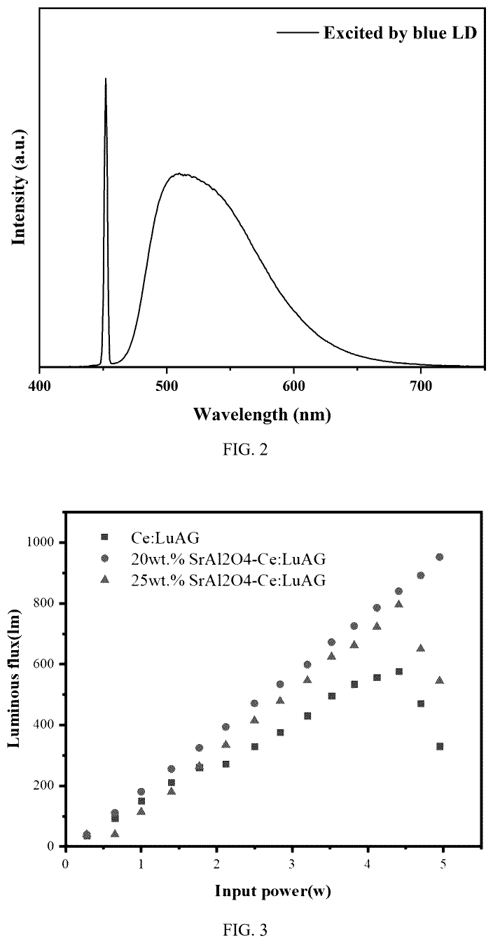

FIG. 2 illustrates an EL spectrum diagram of the sample SrAl₂O₄—Ce:LuAG prepared in the embodiment 2 in the disclosure under excitation by a LD chip at 450 nm. When the input power is 5 W, the luminous flux reaches 1000 lm.

FIG. 3 illustrates a schematic comparison diagram of relationship between luminous flux and input power of the sample of SrAl₂O₄ accounting for 25% of the total mass of the ceramic raw materials prepared in the embodiment 1 in the disclosure, the sample of SrAl₂O₄ accounting for 20% of the total mass of the ceramic raw materials prepared in the embodiment 2 in the disclosure and a pure Ce:LuAG sample. It can be seen from FIG. 3, compared with the pure Ce:LuAG sample, the sample of SrAl₂O₄ accounting for 25% of the total mass of the ceramic raw materials and the sample of SrAl₂O₄ accounting for 20% of the total mass of the ceramic raw materials exhibit excellent luminous performance under the excitation of the blue light LD. When the input power is 5 W, the 20 wt % SrAl₂O₄—Ce:LuAG has no luminous saturation, and its maximum luminous flux can reach 1000 lm.

Apparently, those skilled in the art can make various changes and modifications to the disclosure without departing from a spirit and a scope of the disclosure. Thus, if these modifications and variations of the disclosure fall within a scope of claims of the disclosure and their equivalents, the disclosure is also intended to include these modifications and variations.

What is claimed is:

1. A complex-phase fluorescent ceramic for laser illumination, wherein the complex-phase fluorescent ceramic is prepared from cerium-doped lutetium aluminum garnet (Ce:LuAG) powder and strontium aluminum oxide (SrAl₂O₄) powder as ceramic raw material powder by using a spark plasma sintering method; and Ce:LuAG is configured to be a ceramic body, and SrAl₂O₄ is introduced to prepare the complex-phase fluorescent ceramic.

2. A preparation method of the complex-phase fluorescent ceramic for laser illumination as claimed in claim 1, comprising:
S1, weighing, according to a mass ratio of the Ce:LuAG powder and the SrAl₂O₄ powder, the Ce:LuAG powder and the SrAl₂O₄ powder individually as the ceramic raw material powder, wherein a mass of the SrAl₂O₄ powder accounts for 5% to 25% of a total mass of the ceramic raw material powder;
S2, mixing the Ce:LuAG powder and the SrAl₂O₄ powder to obtain mixed powder, adding anhydrous ethanol into the mixed powder, and ball milling mixed powder added with the anhydrous ethanol fully to obtain a slurry;
S3, taking out and drying the slurry obtained by ball milling to obtain dried powder; and
S4, performing spark plasma sintering on the dried powder under vacuum to obtain sintered powder, and cooling the sintered powder to room temperature to obtain the complex-phase fluorescent ceramic.

3. The preparation method of the complex-phase fluorescent ceramic for laser illumination as claimed in claim 2, wherein in step S1, a particle size of the Ce:LuAG powder is in a range of 1 micron (μm) to 1.3 μm, a particle size of the SrAl₂O₄ powder is in a range of 1.5 μm to 2 μm, and a pureness of each of the Ce:LuAG powder and the SrAl₂O₄ powder is above 99.99%.

4. The preparation method of the complex-phase fluorescent ceramic for laser illumination as claimed in claim 2, wherein in step S2, a speed of the ball milling is in a range of 180 revolutions per minute (rpm) to 250 rpm, and a time of the ball milling is in a range of 15 hours (h) to 30 h.

5. The preparation method of the complex-phase fluorescent ceramic for laser illumination as claimed in claim 2, wherein in step S3, a temperature of the drying is in a range of 70 Celsius degrees (° C.) to 90° C., and a time of the drying is in a range of 8 h to 12 h.

6. The preparation method of the complex-phase fluorescent ceramic for laser illumination as claimed in claim 2, wherein in step S4, a sintering pressure of the spark plasma sintering is in a range of 50 megapascals (MPa) to 100 MPa, a pulse current of the spark plasma sintering is in a range of 200 amperes (A) to 400 A, a heat preservation sintering time of the spark plasma sintering is in a range of 20 minutes (min) to 50 min, and a sintering temperature of the spark plasma sintering is in a range of 1650° C. to 1800° C.
